(19) United States
(12) Patent Application Publication
(10) Pub. No.: US 2025/0358374 A1
(43) Pub. Date: Nov. 20, 2025

(54) INSPECTION SYSTEM

(71) Applicant: CANON KABUSHIKI KAISHA, Tokyo (JP)

(72) Inventor: SHUNSUKE IWANO, Kanagawa (JP)

(21) Appl. No.: 19/207,123

(22) Filed: May 13, 2025

(30) Foreign Application Priority Data
May 17, 2024 (JP) 2024-080807

(51) Int. Cl. H04N 1/00

(52) U.S. Cl. CPC H04N 1/00005; H04N 1/00015; H04N 1/00029; H04N 1/00076; H04N 1/00129

(57) ABSTRACT

An inspection system includes an image forming unit configured to form a test image on both sides of a sheet of paper, a reading unit that is disposed downstream of the image forming unit in a paper conveyance direction and is configured to read the sheet of paper, the reading unit including an upper surface reader configured to read an upper surface of the sheet of paper conveyed by the reading unit, and a lower surface reader configured to read a lower surface of the sheet of paper conveyed by the reading unit, and a controller having a processor which executes instructions stored in a memory or having circuitry, the controller being configured to inspect the lower surface reader based on the test image read by the lower surface reader.

### BACKGROUND

### Field of the Disclosure

The present disclosure relates to an inspection system that inspects an image by reading the image on paper.

### Description of the Related Art

There are known image forming apparatuses that form an image on paper and include an image reader that reads the formed image. The image reader is arranged downstream of an image forming unit in the paper conveyance direction. This arrangement eliminates the need for a user to carry the paper with the image formed thereon to the image reader, thereby saving the user time and trouble.

An image forming apparatus including an image reader performs image diagnosis to determine whether there is a malfunction in the apparatus. The image diagnosis is performed by using a test chart. The test chart is read by the image reader, and the faulty component in the apparatus that causes the image defect is determined from the read image data. Japanese Patent Application Laid-Open No. 2021-144205 discusses a technology for detecting a predetermined pattern in image data and determining whether the predetermined pattern is generated by the image reader.

### SUMMARY

According to embodiments of the present disclosure, an inspection system includes an image forming unit configured to form a test image on both sides of a sheet of paper, a reading unit that is disposed downstream of the image forming unit in a paper conveyance direction and is configured to read the sheet of paper, the reading unit including an upper surface reader configured to read an upper surface of the sheet of paper conveyed by the reading unit, and a lower surface reader configured to read a lower surface of the sheet of paper conveyed by the reading unit, and a controller having a processor which executes instructions stored in a memory or having circuitry, the controller being configured to inspect the lower surface reader based on the test image read by the lower surface reader.

Further features of the present disclosure will become apparent from the following description of exemplary embodiments with reference to the attached drawings.

### BRIEF DESCRIPTION OF THE DRAWINGS

FIG. 1 is a diagram illustrating a network configuration example including a printing system.

FIG. 2 is a cross-sectional view of a hardware configuration example of an image forming apparatus.

FIG. 3 is a block diagram illustrating an internal configuration of the image forming apparatus, an external controller, and a client personal computer (PC).

FIG. 4 is a flowchart illustrating a procedure for an image diagnosis process.

FIG. 5 is a flowchart illustrating a procedure for reader dirt determination.

FIG. 6 is a flowchart illustrating a procedure for an image diagnosis process in a second exemplary embodiment.

FIGS. 7A and 7B are diagrams illustrating examples of test images.

FIGS. 8A and 8B are diagrams illustrating examples of reader dirt determination.

### DESCRIPTION OF THE EMBODIMENTS

Exemplary embodiments will be described with reference to the accompanying drawings. The same components are given the same reference numerals and description thereof will be omitted.

### <Configuration of Overall System>

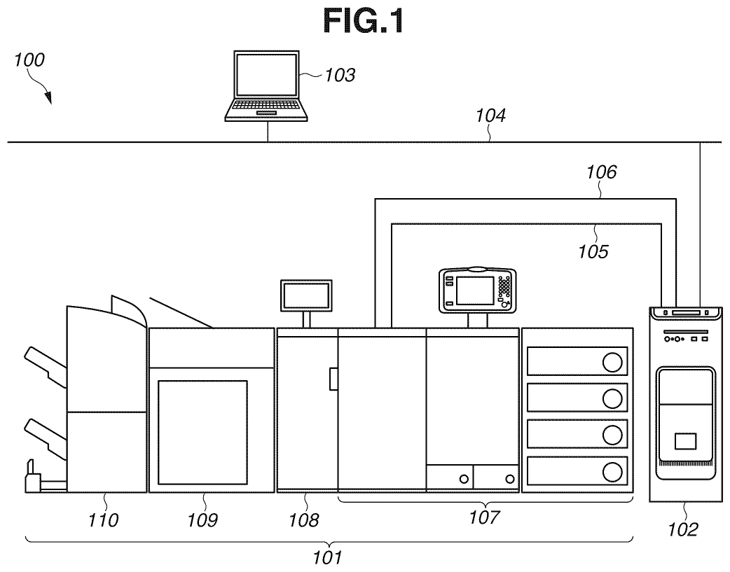

FIG. 1 is a diagram illustrating an example of a network configuration including a printing system (image processing system) according to a first exemplary embodiment. As illustrated in FIG. 1, an inspection system 100 includes an image forming apparatus 101 and an external controller 102. The image forming apparatus 101 and the external controller 102 are communicatively connected via an internal local area network (LAN) 105 and a video cable 106. The external controller 102 is communicatively connected to a client personal computer (PC) 103 via an external LAN 104.

The client PC 103 can provide a print instruction to the external controller 102 via the external LAN 104. Installed in the client PC 103 is a printer driver having a function of converting image data to be printed into a page description language (PDL) that can be processed by the external controller 102. A user who wishes to print can operate the client PC 103 to provide a print instruction from various applications installed in the client PC 103 via the printer driver. The printer driver transmits PDL data, which is print data, to the external controller 102 in response to the print instruction from the user. Upon receipt of the PDL data from the client PC 103, the external controller 102 analyzes and interprets the received PDL data. Based on the interpretation result, the external controller 102 performs a rasterization process to generate a bitmap image (print image data) with a resolution adapted to the image forming apparatus 101, and provides a print instruction by inputting a print job to the image forming apparatus 101.

The image forming apparatus 101 will be described. In the image forming apparatus 101, a plurality of devices having different functions is connected and configured to be capable of performing complex printing processes such as bookbinding.

The image forming apparatus 101 includes an image forming unit 107 (image forming unit), a reading unit 108, a stacker 109, and a finisher 110. Each module will be described.

The image forming unit 107 prints an image in accordance with a print job and ejects the printed recording material. The printed recording material ejected from the image forming unit 107 is conveyed through each device in the order of the reading unit 108, the stacker 109, and the finisher 110. In the present exemplary embodiment, the image forming apparatus 101 of the inspection system 100 is an example of an image forming apparatus, but the image forming unit 107 included in the image forming apparatus 101 may also be called image forming apparatus. The image forming unit 107 forms (prints) an image with toner (color material) on the recording material fed and conveyed from a paper feed unit arranged below the image forming unit 107.

The reading unit 108 is a device that diagnoses a malfunction in the image forming apparatus 101 based on the printed recording material on which an image has been printed by the image forming unit 107 and conveyed through a conveyance path. Specifically, the reading unit 108 reads the image on the conveyed printed recording material and performs diagnosis based on the obtained read image. The malfunction is diagnosed by extracting a diagnosis area from the read image and checking the difference in read signal value within the extracted diagnosis area. Detailed processing by the reading unit 108 as a diagnosis unit will be described below. The use of the reading unit 108 as the diagnosis unit is not limited to the above example.

The reading unit 108 may also has an inspection function for inspecting the presence or absence of printing failures on printed recording materials.

The stacker 109 is a device on which a large number of printed recording materials can be stacked. The finisher 110 is a device capable of performing finishing processes such as stapling, punching, and saddle stitching on the conveyed printed recording materials.

The recording materials having undergone the processing by the finisher 110 are ejected onto a predetermined ejection tray.

In the configuration example of FIG. 1, the external controller 102 is connected to the image forming apparatus 101, but the present embodiment can also be applied to a different configuration. For example, the present embodiment can be applied to a configuration in which the image forming apparatus 101 is connected to the external LAN 104, and print data is transmitted from the client PC 103 to the image forming apparatus 101 without going through the external controller 102. In this case, the analysis and rasterization of the print data are performed by the image forming apparatus 101.

### <Hardware Configuration of Image Forming Apparatus>

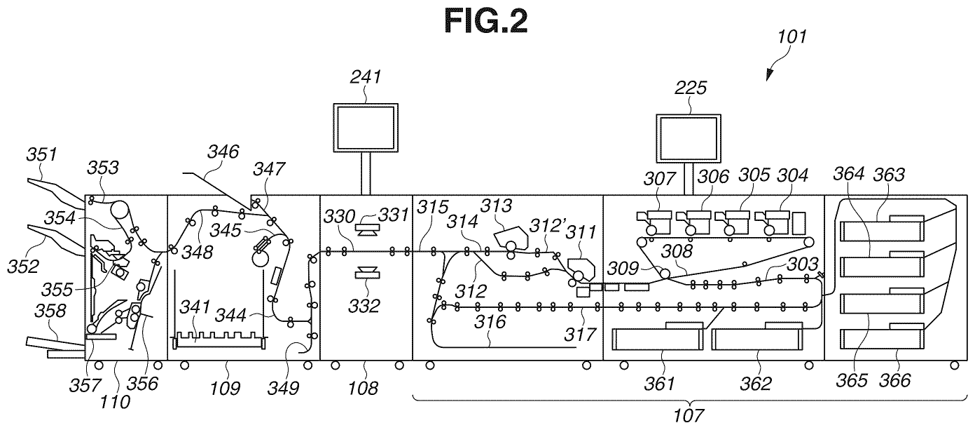

FIG. 2 is a cross-sectional view of a hardware configuration example of the image forming apparatus 101. A specific operation example of the image forming apparatus 101 will be described with reference to FIG. 2.

### <Description of Paper Feed Deck>

The image forming unit 107 includes a plurality of paper feed decks. In the present exemplary embodiment, the image forming unit 107 includes six paper feed decks 361, 362, 363, 364, 365, and 366. Various recording materials (sheets of paper) are stored in the paper feed decks. Among the recording materials stored in the paper feed decks, the uppermost recording material is separated one by one and fed to a conveyance path 303.

The paper size is automatically acquired by reading the position of a guide (not illustrated) in each paper feed deck with a sensor. Other information is acquired by the user selecting and inputting the information on a paper information change screen described below. In the present exemplary embodiment, only a portion of the paper information is acquired by the sensor provided in the paper feed deck, but the present disclosure is not limited to the above example. For example, a configuration may be adopted in which a sheet of paper stored in the paper feed deck is passed through and the paper information is determined based on an image read from the sheet of paper by a reading device described below.

Image forming stations 304 to 307 include photosensitive drums (photoconductors) and form toner images on their photosensitive drums using toner of different colors. Specifically, the image forming stations 304 to 307 form toner images using toner of yellow (Y), magenta (M), cyan (C), and black (K), respectively.

The color toner images formed in the image forming stations 304 to 307 are transferred in sequence onto an intermediate transfer belt 308, and superimposed on each other (primary transfer). The toner images on the intermediate transfer belt 308 are conveyed to a secondary transfer position 309 by the rotation of the intermediate transfer belt 308. At the secondary transfer position 309, the toner images are transferred from the intermediate transfer belt 308 onto the recording material having been conveyed through the conveyance path 303 (secondary transfer). The recording material having undergone the secondary transfer is conveyed to a fixing unit 311. The fixing unit 311 includes a pressure roller and a heating roller. During passage through these rollers, the recording material is placed under heat and pressure, thereby a fixing process to fix the toner image onto the recording material is performed. The recording material having passed through the fixing unit 311 is conveyed through a conveyance path 312 to a connection point 315 between the image forming unit 107 and the reading unit 108. In this manner, a color image is formed (printed) on the recording material.

If a further fixing process is required depending on the type of the recording material, the recording material having passed through the fixing unit 311 is guided to a conveyance path 314 provided with a fixing unit 313. The fixing unit 313 performs a further fixing process on the recording material conveyed through the conveyance path 314. The recording material having passed through the fixing unit 313 is conveyed to the connection point 315. If the operation mode is a mode for performing double-sided printing, the recording material having an image printed on the first side is conveyed through the conveyance path 312 or the conveyance path 314, and guided to a reversing path 316. The recording material is reversed in the reversing path 316 and guided to a double-sided conveyance path 317, and then conveyed to the secondary transfer position 309. Accordingly, toner images are transferred to the second side of the recording material that is opposite to the first side, at the secondary transfer position 309. Thereafter, the recording material passes through the fixing unit 311 (and the fixing unit 313), thereby completing the formation of a color image on the second side of the recording material. The reversing path 316 is arranged upstream of the reading unit 108 and downstream of the image forming unit 107 in the paper conveyance direction.

Upon completion of the image formation (printing) at the image forming unit 107, the printed recording material is conveyed to the connection point 315 and then conveyed into the reading unit 108.

The reading unit 108 includes an upper surface reader 331 and a lower surface reader 332 that have contact image sensors (CISs) on a conveyance path 330 in which the printed recording material is conveyed from the image forming unit 107. The upper surface reader 331 and the lower surface reader 332 are disposed at positions facing each other across the conveyance path 330. The upper surface reader 331 and the lower surface reader 332 are configured to read the upper surface (first side) and the lower surface (second side) of the paper conveyed in the reading unit 108, respectively. The upper surface reader 331 and the lower surface reader 332 may include charge coupled devices (CCDs) or line scan cameras instead of the CISs, for example.

The reading unit 108 performs image diagnosis (diagnosis unit) to determine whether there is a faulty component in the image forming apparatus 101 based on the image printed on the printed recording material conveyed through the conveyance path 330.

Specifically, when the printed recording material being conveyed reaches a predetermined position, the reading unit 108 performs a reading process using the upper surface reader 331 and the lower surface reader 332 to read the image on the printed recording material.

The reading unit 108 operates in response to an instruction from a user to execute an image diagnosis process.

The image diagnosis process is preferably performed before the start of a print job or in the event of continuous printing failures, for example. The recording materials having passed through the reading unit 108 are conveyed to the stacker 109 in sequence.

The stacker 109 includes a stack tray 341 on which printed recording materials having been conveyed from the reading unit 108 disposed upstream in the conveyance direction of the printed recording materials are stacked. The printed recording materials having passed through the reading unit 108 are conveyed along a conveyance path 344 in the stacker 109. When the printed recording materials are conveyed along the conveyance path 344 and guided to a conveyance path 345, the printed recording materials are stacked on the stack tray 341.

The stacker 109 further includes an escape tray 346 as a paper ejection tray. In the present exemplary embodiment, the escape tray 346 is used to eject a recording material on which a test chart used for image diagnosis by the reading unit 108 has been recorded. When a printed recording material is conveyed along the conveyance path 344 and guided to a conveyance path 347, the printed recording material is conveyed to the escape tray 346. A printed recording material having not been stacked or ejected in the stacker 109 is conveyed to the downstream finisher 110 via a conveyance path 348.

The stacker 109 further includes a reversing unit 349 that inverts the orientation of the printed recording material being conveyed. The reversing unit 349 is used to make the orientation of the recording material in the stacker 109 identical to the orientation of the printed recording material stacked on the stack tray 341 and output from the stacker 109, for example. The reversing unit 349 does not perform a reversing operation on the printed recording material that is not stacked in the stacker 109 but conveyed to the finisher 110.

The finisher 110 performs a finishing function designated by a user on the printed recording material having been conveyed from the reading unit 108 disposed upstream in the conveyance direction of the printed recording material. In the present embodiment, the finisher 110 has finishing functions such as stapling (binding at one or two places), punching (punching two or three holes), and saddle stitching. The finisher 110 has two ejection trays 351 and 352. If no finishing process is to be performed by the finisher 110, the printed recording material having been conveyed to the finisher 110 is ejected to the ejection tray 351 through a conveyance path 353. If a finishing process such as stapling is to be performed by the finisher 110, the printed recording material having been conveyed to the finisher 110 is guided to a conveyance path 354. The finisher 110 uses a finishing processing unit 355 to perform a finishing process specified by the user on the printed recording material having been conveyed along the conveyance path 354, and ejects the printed recording material having undergone the finishing process to the ejection tray 352.

### <Functional Configuration Diagram>

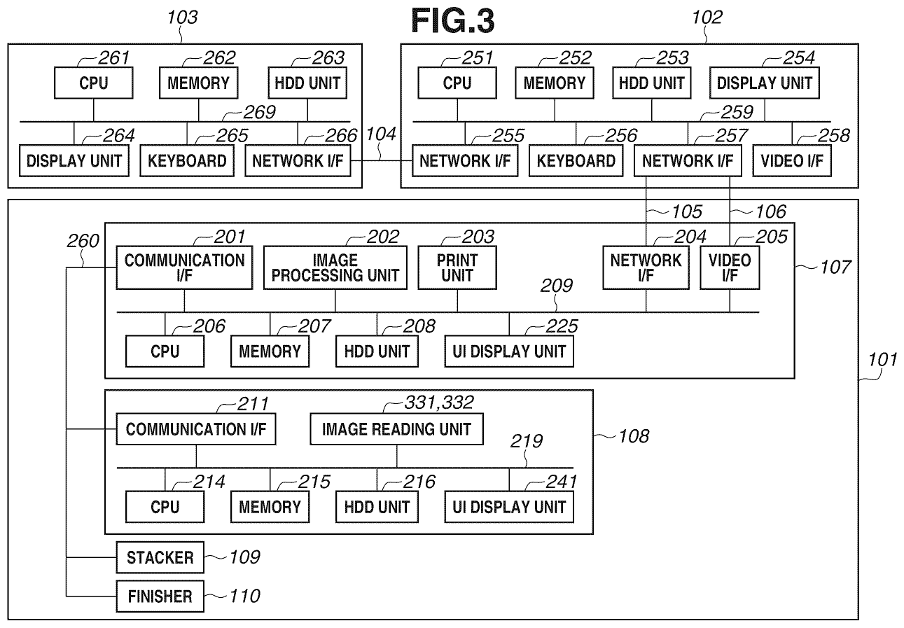

FIG. 3 is a schematic functional block diagram of the image forming apparatus 101, the external controller 102, and the client PC 103.

The image forming unit 107 of the image forming apparatus 101 includes a communication interface (I/F) 201, a network I/F 204, a video I/F 205, a central processing unit (CPU) 206, a memory 207, a hard disk drive (HDD) unit 208, and a user interface (UI) display unit 225. The image forming unit 107 further includes an image processing unit 202 and a print unit 203. They are connected to each other via a system bus 209 so as to be able to transmit and receive data. The communication I/F 201 is connected to the reading unit 108, the stacker 109, and the finisher 110 via a communication cable 260. The CPU 206 performs communication to control each device via the communication I/F 201. The network I/F 204 is connected to the external controller 102 via the internal LAN 105 and is used to communicate control data and the like. The video I/F 205 is connected to the external controller 102 via a video cable 106 and is used to communicate data such as image data and the like. The image forming unit 107 (image forming apparatus 101) and the external controller 102 may be connected only by the video cable 106, as long as the external controller 102 can control the operation of the image forming apparatus 101. The HDD unit 208 saves various programs and data.

The CPU 206 controls the overall operation of the image forming unit 107 by executing programs saved in the HDD unit 208. The memory 207 stores programs and data required by the CPU 206 to perform various processes. The memory 207 operates as a work area for the CPU 206. The UI display unit 225 accepts various setting inputs and operation instructions from the user, and is used to display various types of information such as setting information and the processing status of a print job. For example, the UI display unit 225 receives various instructions from the user, such as instructions to execute or set a diagnosis, set paper information, and the like.

The reading unit 108 includes a communication I/F 211, a CPU 214, a memory 215, an HDD unit 216, the upper surface reader 331, the lower surface reader 332, and a UI display unit 241. These devices are connected to each other via a system bus 219 so as to be able to transmit and receive data. The communication I/F 211 is connected to the image forming unit 107 via a communication cable 260. The CPU 214 performs communication required for controlling the reading unit 108 via the communication I/F 211. The CPU 214 controls the operation of the reading unit 108 by executing a control program stored in the memory 215. The memory 215 saves the control program for the reading unit 108. The upper surface reader 331 and the lower surface reader 332 read the images on the conveyed recording material in response to an instruction from the CPU 214. The CPU 214 determines the presence or absence of a malfunction in the image forming apparatus 101 based on the diagnostic images read by the upper surface reader 331 and the lower surface reader 332. The UI display unit 241 is used to display the diagnosis results, setting screens, and the like. The operation unit also serves as the UI display unit 241 and is operated by the user to receive various instructions from the user to change the settings of the reading unit 108, execute an image diagnosis, and the like. The HDD unit 216 saves various types of setting information and image data required for image diagnosis. The various types of setting information and image data saved in the HDD unit 216 can be reused.

The stacker 109 performs control to eject the printed recording material having been conveyed along the conveyance path to the stack tray or to the escape tray, or convey the same to the finisher 110 connected downstream in the conveyance direction of the printed recording material.

The finisher 110 controls the conveyance and ejection of the printed recording materials, and performs finishing processes such as stapling, punching, or saddle stitching.

The external controller 102 includes a CPU 251, a memory 252, an HDD unit 253, a keyboard 256, a display unit 254, network I/Fs 255 and 257, and a video I/F 258. These devices are connected to each other via a system bus 259 so as to be able to transmit and receive data. The CPU 251 executes programs saved in the HDD unit 253 to control the overall operations of the external controller 102, such as receiving print data from the client PC 103, raster image processor (RIP) processing, and transmitting print data to the image forming apparatus 101, for example. The memory 252 stores programs and data required for the CPU 251 to perform various processes. The memory 252 operates as a work area for the CPU 251.

The HDD unit 253 saves various programs and data. The keyboard 256 is used by the user to input operation instructions to the external controller 102. The display unit 254 is a display, for example, and is used for displaying information about an application currently running in the external controller 102 and an operation screen. The network I/F 255 is connected to the client PC 103 via the external LAN 104 and is used to communicate data such as print instructions. The network I/F 257 is connected to the image forming apparatus 101 via the internal LAN 105 and is used to communicate data such as print instructions. The external controller 102 is communicable with the image forming unit 107, the reading unit 108, the stacker 109, and the finisher 110 via the internal LAN 105 and the communication cable 260. The video I/F 258 is connected to the image forming apparatus 101 via the video cable 106 and is used to communicate data such as image data (print data).

The client PC 103 includes a CPU 261, a memory 262, an HDD unit 263, a display unit 264, a keyboard 265, and a network I/F 266. These devices are connected to each other via a system bus 269 so as to be able to transmit and receive data. The CPU 261 controls the operation of each device via the system bus 269 by executing programs saved in the HDD unit 263. This enables the client PC 103 to perform various processes. For example, the CPU 261 generates print data and provides a print instruction by executing a document processing program saved in the HDD unit 263. The memory 262 stores programs and data required for the CPU 261 to perform various processes. The memory 262 operates as a work area for the CPU 261.

The HDD unit 263 saves various applications such as a document processing program, programs about a printer driver and like, and various data, for example. The display unit 264 is a display, for example, and is used to display information about an application currently running on the client PC 103 and an operation screen. The keyboard 265 is used by the user to input operation instructions to the client PC 103. The network I/F 266 is communicably connected to the external controller 102 via the external LAN 104. The CPU 261 communicates with the external controller 102 via the network I/F 266.

### <Image Diagnosis>

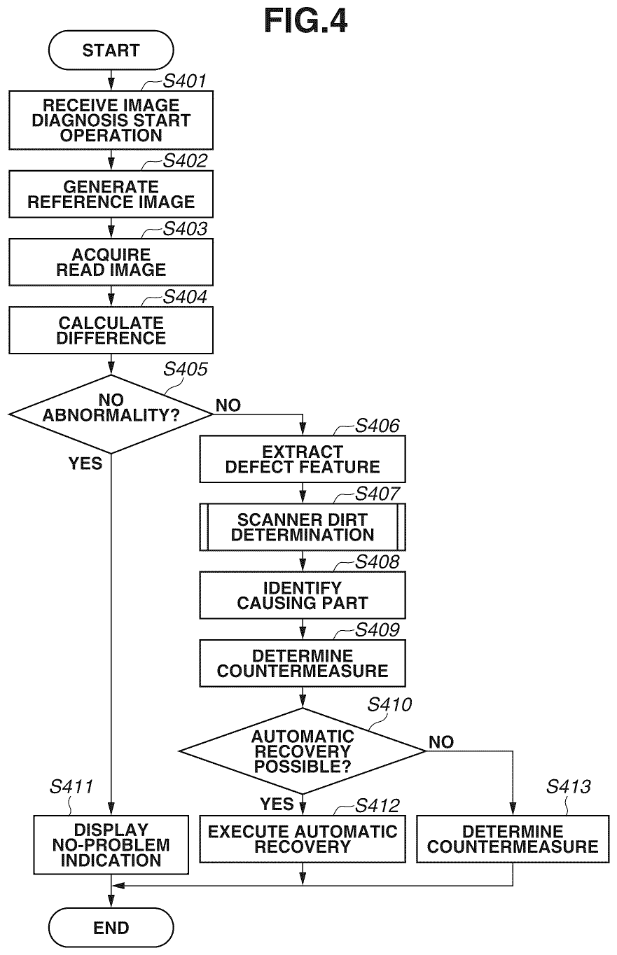

An image diagnosis process using a test chart image according to the present exemplary embodiment (hereinafter, also referred to as test image diagnosis) will be described with reference to the drawings. FIG. 4 is a flowchart illustrating the procedure for a print operation executed by the image forming unit 107 and an image diagnosis process executed by the reading unit 108. FIG. 4 illustrates an overall flow from an operation before start of the image diagnosis to the execution of the image diagnosis. The symbol “S” used in the description of the flowchart represents a step. This also applies to the description of the following flowcharts. The steps in FIG. 4 are executed by the CPU 206 of the image forming unit 107 and the CPU 214 of the reading unit 108.

In step S401, the inspection system 100 receives an instruction for test image diagnosis from a user or a serviceman via the UI display unit 241, which also serves as an operation unit. When the inspection system 100 receives the instruction for test image diagnosis, a test image is formed by a test image forming unit. Details will be described below.

In the present exemplary embodiment, the timing for starting the image diagnosis process is after power-on and startup of the main body, for example. After the startup, the inspection system 100 displays a notice for prompting the user to start a diagnosis, on one or more of the UI display unit 241, the display unit 254 of the external controller 102, and the UI display unit 225 of the image forming unit 107. The timing for starting the image diagnosis process is not limited to the above example. In the case where the inspection system 100 includes an inspection function for inspecting the presence or absence of printing defects on printed recording material, the user may be prompted to start the image diagnosis process if defects are found consecutively by the inspection function.

Furthermore, a configuration may be adopted in which the timer is set for a time at which a notification for prompting the user to execute the image diagnosis process is displayed, so that the notification is displayed at the set time instead of after the start-up of the main body.

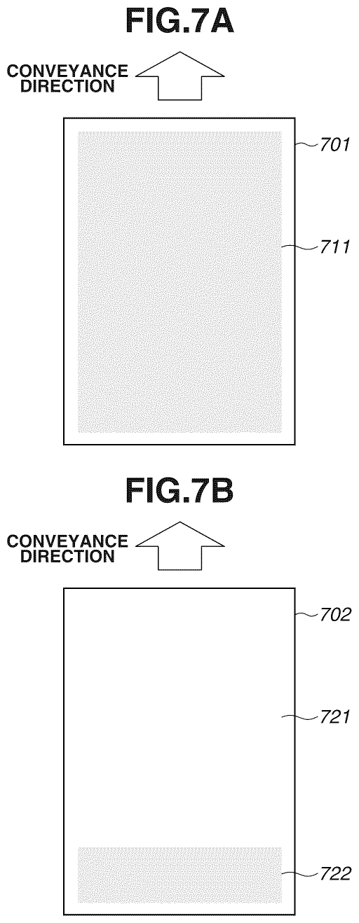

In step S402, the test image forming unit forms a test image. The CPU 251 of the external controller 102 reads out a test chart saved in advance, rasterizes it into a bitmap, and creates a rasterized bitmap of the test chart as a reference image. The test chart is an image for diagnosing a malfunction in the image forming apparatus. FIGS. 7A and 7B are diagrams illustrating examples of test charts used in the image diagnosis process in the present exemplary embodiment. A single-sided test chart 701 in FIG. 7A represents an example of single-sided printing in which a test image is formed on one side of a paper sheet and no image is formed on the other side. In the single-sided test chart 701, a test image is formed on the entire surface of an area in which an image can be formed by the image forming unit 107. A test image 711 is formed with a color material in the area. For example, the test image 711 is obtained by using a single-color image with an area ratio of 50%, and printing a total of four types of test charts, one type for each single color of CMYK.

A double-sided test chart 702 in FIG. 7B is an example of a test chart for detecting dirt on the reader. The double-sided test chart 702 is printed on both sides of a recording material. The double-sided test chart 702 includes a non-image portion 721 and a test image 722. The non-image portion 721 is in an area that is located at the leading edge of the double-sided test chart 702 in the conveyance direction and in which no image is formed. The test image 722 is in an area that is located at the part other than the leading edge of the double-sided test chart 702 in the conveyance direction and in which an image is formed with a color material. The test image 722 is printed with a single color of K at an area ratio of 50%, for example. The non-image portion 721 is intended to make it easier to detect dirt on the reader in a color different from that of the recording material, and the test image 722 is intended to make it easier to detect dirt on the reader in a color similar to that of the recording material. By reading the test image 722 by the lower surface reader 322, dirt of a color similar to that of the paper sheet can be detected.

The CPU 251 transmits the bitmap data of the rasterized test charts from the video I/F 258 to the video I/F 205 of the image forming unit 107 through the video cable 106. The CPU 206 of the image forming unit 107 performs halftone processing on the bitmap data of the test charts received by the video I/F 205, and the print unit 203 prints the test charts based on the image data having undergone the halftone processing. In order to facilitate detection of image defects that occur periodically, the single-sided test chart 701 is printed, and then the double-sided test chart 702 is printed. The above configuration of the test charts is an example, and the present disclosure is not limited to the above example. As far as defects in the printed portion can be apparent by a difference image described below, the ratio of the image portion to the non-image portion or the area ratio may be different, and the image portion may be formed with two or more color materials. The double-sided test chart 702 may have two or more image portions of different colors instead of the non-image portion and the image portion, such that dirt on the reader that is difficult to detect in one image portion can be easily detected in the other image area. In the present exemplary embodiment, only the last test chart is double-sided printed, but all pages may be double-sided printed, or the first and last pages may be double-sided printed.

In step S403, the CPU 214 of the reading unit 108 executes a process of reading the printed test charts by the upper surface reader 331 and the lower surface reader 332. The read images of the test charts are saved as diagnostic images in the HDD unit 216 of the reading unit 108. After the diagnostic images are saved, the process proceeds to step S404. The lower surface reader 332 reads the test image 722 formed on the lower surface of the double-sided test chart 702.

In step S404, the CPU 214 compares the read image with the reference image to determine whether there is a malfunction in the printing unit. In the present exemplary embodiment, the CPU 214 compares the read image with the reference image and calculates a difference value.

If the calculated difference value exceeds a preset threshold, the CPU 214 determines that there is a difference, and sets 1 to the difference image data. On the other hand, if the calculated difference value is below the threshold, the CPU 214 sets 0 to the difference image data.

The method for calculating the difference image data is not limited to the above example. In the present exemplary embodiment, the read image and the reference image are compared to calculate the difference value. Alternatively, the average value may be calculated from the read image to calculate the difference value as a reference signal, or a value assumed as a reference signal may be saved in the HDD unit 216 in advance. A correction unit may be provided to correct nonlinearity between the signal value and brightness of the read image acquired by the reader, and the signal value of the read image may be corrected before calculating the difference image data. The CPU 214 saves the difference image data, which is binary data indicating the presence or absence of a difference, in the HDD unit 216, and the process proceeds to step S405.

Upon completion of the creation of the difference image data, in step S405, the CPU 214 determines whether the image forming apparatus 101 is normal. The determination is made based on whether data including 1 is present in the difference image data. If the CPU 214 determines that the image forming apparatus 101 is normal (YES in step S405), the process proceeds to step S411. In step S411, the CPU 214 displays a “No problem” message, which indicates that the diagnosis result is normal, on the UI display unit 241 of the reading unit 108. If the CPU 214 determines that the image forming apparatus 101 is not normal (the difference image data includes 1) (NO in step S405), the process proceeds to step S406. In step S406 and subsequent steps, the CPU 214 identifies a faulty component in the image forming apparatus 101 based on the read image data and the difference image data, and instructs a countermeasure.

In step S406, the CPU 214 extracts feature information for identifying a faulty component in the image forming unit 107 from the read image data and the difference image data. The CPU 214 extracts the feature of the difference from the read image corresponding to the difference area determined as having a difference calculated from the difference image data in step S404. The feature information about the difference area obtained by this extraction process includes color material information indicating the color in which the defect has occurred, yellow, magenta, cyan, or black, for example. The feature information also includes contrast information that indicates the defect density contrast as a difference in the dark direction (positive direction) or a difference in the light direction (negative direction) by a positive or negative numerical value. The feature information further includes size information such as the width (size in the main scanning direction) and height (size in the sub-scanning direction) of the defect, and shape information such as the shape of a dot, vertical streak, or horizontal streak. In the present exemplary embodiment, as an example, the shape information is obtained based on the aspect ratio of the width and height in the obtained size information. Specifically, if the aspect ratio determined by dividing the width by the height exceeds a predetermined threshold, the defect is determined as being a horizontal streak. If the aspect ratio is equal to or less than the threshold, the defect is determined as being a vertical streak. If the aspect ratio does not fall into either category, the defect is determined as being a dot. The acquisition of the shape information is not limited to the above example, and any method for determining the shape of the defect, such as dot, horizontal streak, or vertical streak, may be used. For example, the defect with a width equal to or greater than a threshold may be determined as being a horizontal streak, the defect with a height equal to or greater than a threshold may be determined as being a vertical streak, and the defect other than the above may be determined as being a dot. In the image portion of the user image, a defect may be intermittent or not occur depending on the pattern, so the threshold may be changed according to the pattern, or a process of joining interrupted portions of a streak may be performed before making a defect shape determination. Examples of the feature information include coordinate information indicating the position of the defect in a direction perpendicular to the conveyance direction of the test chart in the image forming unit 107, and periodic information indicating periodic occurrence of defects with similar features in the conveyance direction of the test chart in the image forming unit 107. The CPU 214 saves the extracted feature information in the HDD unit 216, and the process proceeds to step S407.

In step S407, the CPU 214 determines, based on the feature information about the difference region obtained in step S406, whether the image defect has been caused by either the upper surface reader 331 or the lower surface reader 332. Details will be described below.

In step S408, the CPU 214 identifies the component that has caused the image defect, in the image forming unit 107, the upper surface reader 331, and the lower surface reader 332, based on the feature information about the difference region and the result of determination about whether the defect has been caused by dirt on the reader. In the difference region, the CPU 214 selects a combination of defect portions of the same color with high similarity, and identifies the faulty component from the periodic information about the selected combination. For the image defects determined as having been caused by dirt on the reader in step S407, the CPU 214 does not perform determination on other components. The CPU 214 determines the image defect portions at the same main scanning position as having been caused by dirt on the reader.

In step S409, the CPU 214 determines a countermeasure against the image defect, based on the component that is the cause identified in step S407. The countermeasures include countermeasures capable of automatic restoration and countermeasures incapable of automatic restoration. Examples of the countermeasures capable of automatic restoration include countermeasures capable of automatic restoration by the image forming unit 107, such as cleaning the wires and grids of the corona chargers that electrically charge the photosensitive drums provided in the image forming stations 304 to 307 of the image forming unit 107. The countermeasures incapable of automatic restoration include the following two examples. First example includes countermeasures that require user work, such as removing dirt from the reading glass surfaces of the upper surface reader 331 and the lower surface reader 332 of the reading unit 108, adjusting the recording materials to be used, and countermeasures that require service personnel work, such as replacing components. Second example includes countermeasures against abnormal reading of the image reader, fibers or foreign matter that have intruded into the recording material before image formation, and the like. If there is any countermeasure capable of automatic restoration, automatic recovery control may be executed.

In step S410, the CPU 214 determines whether the countermeasure determined in step S409 is a countermeasure capable of automatic recovery. If the CPU 214 determines that the countermeasure determined in step S409 is a countermeasure capable of automatic recovery (YES in step S410), the process proceeds to step S412.

In step S412, the CPU 214 executes automatic recovery control corresponding to the cause of the image defect.

If the CPU 214 determines that the determined countermeasure is not a countermeasure capable of automatic recovery (NO in step S410), the process proceeds to step S413. In step S413, the CPU 214 displays the image diagnosis result and the countermeasure method on the UI display unit 241 of the reading unit 108. Upon completion of any one of steps S411 to S413 described above, the process in the flow (image diagnosis process) illustrated in FIG. 4 is terminated.

### <Reader Dirt Determination Process>

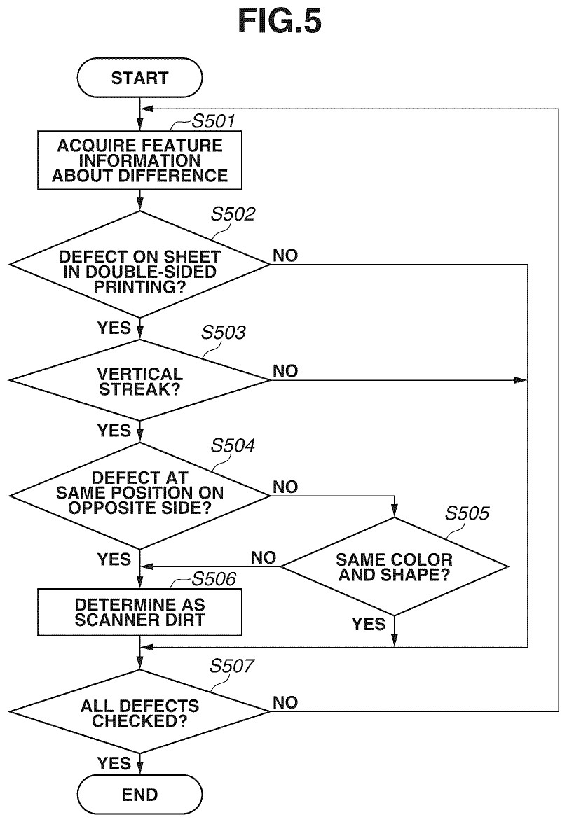

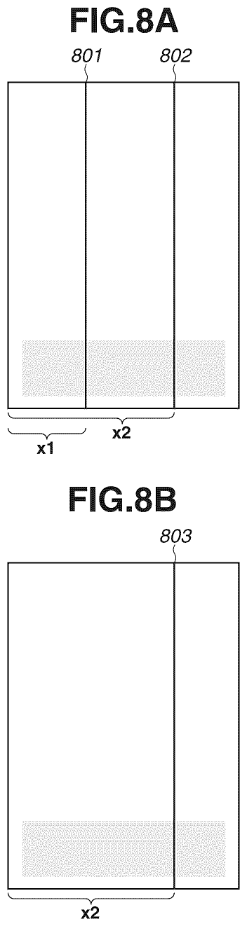

The dirt determination process on the reader (scanner) according to the present exemplary embodiment will be described with reference to FIGS. 5, 8A, and 8B.

FIGS. 8A and 8B illustrate examples of read images at the time of double-sided printing. FIG. 8A illustrates an example of an image read by the upper surface reader 331, and FIG. 8B illustrates an example of an image read by the lower surface reader 332. A streak 801 is an example of an image defect caused by dirt on the upper surface reader 331. The dirt on the upper surface reader 331 is reflected on only the image read by the upper surface reader 331. In a configuration in which an image being conveyed is read by the CIS as in the present exemplary embodiment, dirt on the reader leads to a streak-like image defect parallel to the conveyance direction, like the streak 801. The dirt on the reader is caused by paper powder or dust adhering to the reading surface of the CIS, and the color of the image defect differs depending on the type of dirt. Streaks 802 and 803 are examples of streak-like image defects caused by the same abnormality in the image forming unit 107. In the operation mode of double-sided printing, after an image is printed on the first side of a sheet, the sheet is inverted in the reversing path 316, and the second side is printed using the same components as those used for printing the first side. For this reason, if streak-like image defects occur due to an abnormality in any of the corona chargers, which are the charging units for the photosensitive drums provided in the image forming stations 304 to 307 of the image forming unit 107, for example, the image defects will be located at close main scanning positions on both sides of the sheet, like the streaks 802 and 803.

FIG. 5 is a flowchart illustrating a procedure for the dirt determination process on the reader executed by the reading unit 108. The steps in the flowchart in FIG. 5 are executed by the CPU 214 of the reading unit 108.

In step S501, the CPU 214 reads and acquires the feature information about a difference extracted from the HDD unit 216 in step S406.

In step S502, the CPU 214 determines whether the sheet with the difference has been processed in the double-sided printing mode. The determination may be made from the processing information about the print job, or from the page number in the case of using test charts. If the CPU 214 determines that the sheet has been processed in the double-sided printing mode (YES in step S502), the process proceeds to step S503.

In step S503, the CPU 214 refers to the feature information about the difference and determines whether the image defect has been determined as a vertical streak. If the CPU 214 determines that the image defect has been determined as a vertical streak (YES in step S503), the CPU 214 determines that there is a possibility that there is dirt on the reader, and the process proceeds to step S504.

In step S504, the CPU 214 determines whether an image defect is present at the same position on the side opposite to the side on which the currently focused image defect is present. For example, when the main scanning position of the streak 801 in FIG. 8A is x1, the CPU 214 determines whether an image defect is present at the main scanning position x1 on the opposite side in FIG. 8B. Since no image defect is present on the opposite side at the same main scanning position x1 as the streak 801, the CPU 214 determines that no image defect is present at the same position on the opposite side. Since the streak 803 is present on the opposite side at the same main scanning position x2 as the streak 802, the CPU 214 determines that an image defect is present at the same position on the opposite side. Whether the positions of the image defects are the same is determined using a certain threshold value, taking an error into consideration. If the CPU 214 determines that an image defect is present at the same position on the opposite side (YES in step S504), the process proceeds to step S506. If the CPU 214 determines that no image defect is present at the same position on the opposite side (NO in step S504), the process proceeds to step S505. In step S506, the CPU 214 determines that the cause is a defect in the reader.

The streak 801 in FIG. 8A will be taken as an example. The streak 801 is an example of an image defect caused by dirt on the upper surface reader 331. If a streak does not appear on the side of the paper read by the lower surface reader 332 like the streak 801, the streak 801 is determined as a defect caused by the upper surface reader 331. On the other hand, if a streak appears on the side of the paper read by the lower surface reader 332 but not on the side of the paper read by the upper surface reader 331, the streak is determined as a defect caused by the lower surface reader 332.

In step S505, the CPU 214 refers to the feature information acquired in step S501 and determines whether the image defect present at the same position on the opposite side is similar to the currently focused image defect. If the defects have the same color and shape, the CPU 214 determines that the defects are similar defects (YES in step S505).

The determination may be made using other features. For example, the determination may be made based on the thickness of a streak-like defect, the size or contrast of a dot-like defect, or the defect portions may be extracted to calculate the similarity by image comparison. If the CPU 214 determines that the defects are not similar (NO in step S505), the CPU 214 determines that the cause of these image defects is another, and the process proceeds to step S506. In step S506, the CPU 214 determines that the cause is a malfunction in the reader.

In step S507, the CPU 214 determines whether the reader dirt determination has been completed on all image defects. If the CPU 214 determines that the reader dirt determination has been completed (YES in step S507), the process is ended. If the CPU 214 determines that the reader dirt determination has not been completed (NO in step S507), the process proceeds to step S501. In step S501, the CPU 214 performs determination on the next image defect. In this manner, if it is determined that the same defects are present on both sides of a sheet of paper where test images have been printed, it is determined that there is a malfunction in the image forming unit, not in the reader.

When a faulty location is identified by diagnosis of test images, the inspection system 100 notifies the user of the faulty location. As a notification means, it is preferable to display a message on an operation unit that can be operated by the user, such as the UI display unit 225 or the display 241, for example.

As described above, even if dirt on the reading device has the same color as that of the background member and is unlikely to be reflected on the background member, it is possible to accurately determine whether an image defect is due to the dirt on the reading device and a malfunction in the image forming apparatus.

An image diagnosis process according to a second exemplary embodiment will be described. In the first exemplary embodiment, the image diagnosis process is performed using test charts as described above. However, the advantageous effects of the present disclosure are not limited to the above-described example. For example, during printing of a user image, image diagnosis may be performed using the user image. In printing the user image, the print pages do not necessarily include the page on which the above-described reader dirt determination process can be performed. Accordingly, even in such a case, control is performed to change job information such that the above-described reader dirt determination process can be performed, and the dirt on the reader is determined.

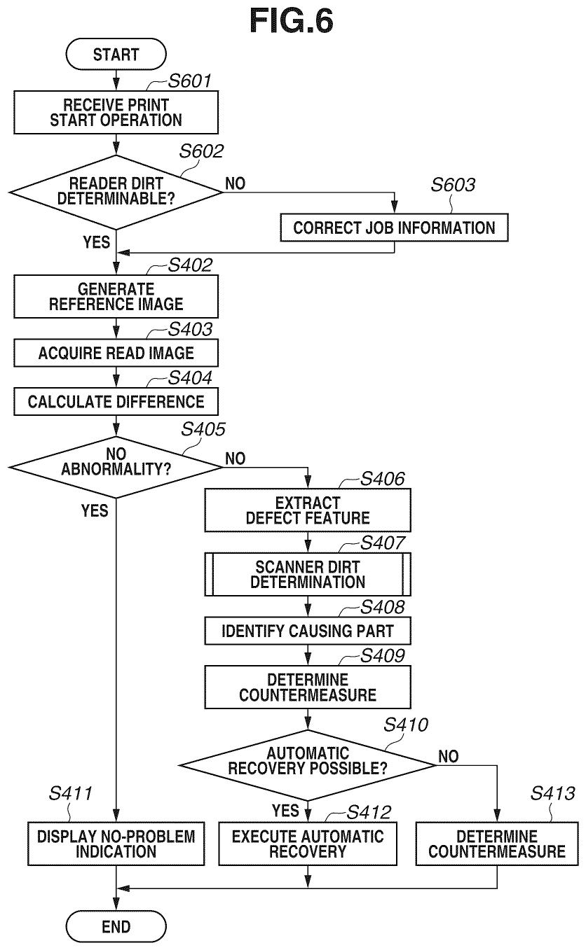

The process of image diagnosis using a user image according to the present exemplary embodiment (hereinafter, also referred to as user image diagnosis) will be described with reference to the drawing. FIG. 6 is a flowchart illustrating the procedure for a print operation executed by the image forming unit 107 and an image diagnosis process executed by the reading unit 108. FIG. 6 illustrates the overall flow from the work before the start of image diagnosis to the execution of diagnosis. The steps in FIG. 6 are executed by the CPU 206 of the image forming unit 107 and the CPU 214 of the reading unit 108. The same steps as those described above are denoted by the same reference numerals and description thereof will be omitted.

In step S601, the inspection system 100 receives an instruction for starting a user image diagnosis from a user or a serviceman via the UI display unit 241, which also serves as an operation unit. In the present exemplary embodiment, the user image diagnosis process is started when a print job is executed. A job setting to specify whether to execute a user image diagnosis may be provided such that the user image diagnosis is started only when the setting is on. The timing for starting the image diagnosis process is not limited to the above example. For example, the user image diagnosis may be started when proof printing is executed.

In step S602, the inspection system 100 determines whether the print job includes pages on which the reader dirt determination process can be performed. The pages on which the reader dirt determination process can be performed are pages on which images are to be formed on both front and back sides. If there are pages on which images are to be formed on both front and back sides, printing do not have to be made on the same sheet. It may be determined that the print job includes a pattern from which the reader dirt can be detected. The pattern from which the reader dirt can be detected has an image portion with an area and density from which a white streak-like defect caused by the reader dirt can be detected in a difference calculation process described below, and has a non-printed portion with an area from which a black streak-like defect caused by the reader dirt can be detected, for example. If the CPU 214 determines that the print job includes pages on which the reader dirt determination process can be performed (YES in step S602), the process proceeds to step S402. If the CPU 214 determines that the print job includes no pages on which the reader dirt determination process can be performed (NO in step S602), the process proceeds to step S603.

In step S603, the inspection system 100 corrects the job information to determine the dirt on the reader. If it is determined in step S602 that there are no pages on which images are to be formed on the front and back sides, a page with only a non-image portion is added to the opposite side of the last page of the print job, and the operation mode for the last page is set to double-sided printing. Pages with only a non-image portion may be added such that the operation mode for double-sided printing is set for the first page, all pages, or the first and last pages. The printing sides may be unified by interchanging the printing sides during the print job and reversing them in the reversing unit 349 of the stacker 109. A sheet for detecting dirt on the reader, such as the sheet with the double-sided test chart 702 illustrated in FIG. 7B, may be added as the first or last sheet of the job.

As described above, even when image diagnosis is performed during printing of user images that do not include double-sided printing pages, it is possible to accurately determine whether an image defect is due to dirt on the reading device or a malfunction in the image forming apparatus.

Detecting the occurrence of dirt on the image reader that reads an image on the side on which no image is to be formed during single-sided printing makes it possible to identify the faulty component by performing image diagnosis using test charts. This suppresses the occurrence of the defect in the subsequent jobs.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-080807, filed May 17, 2024, which is hereby incorporated by reference herein in its entirety.

What is claimed is:

1. An inspection system comprising:
an image forming unit configured to form a test image on both sides of a sheet of paper;
a reading unit that is disposed downstream of the image forming unit in a paper conveyance direction and is configured to read the sheet of paper, the reading unit including an upper surface reader configured to read an upper surface of the sheet of paper conveyed by the reading unit, and a lower surface reader configured to read a lower surface of the sheet of paper conveyed by the reading unit; and
a controller having a processor which executes instructions stored in a memory or having circuitry, the controller being configured to inspect the lower surface reader based on the test image read by the lower surface reader.

2. The inspection system according to claim 1, wherein the image forming unit is capable of single-sided printing of the test image.

3. The inspection system according to claim 2, wherein in forming the test image by the image forming unit, the test image is formed by single-sided printing and double-sided printing.

4. The inspection system according to claim 3, wherein in forming the test image by the image forming unit, a last sheet of paper on which the test image is to be formed by the image forming unit is double-sided printed.

5. The inspection system according to claim 3, wherein in forming the test image by the image forming unit, a first sheet of paper on which the test image is to be formed by the image forming unit is double-sided printed.

6. The inspection system according to claim 1, wherein the controller diagnoses the upper surface reader based on the test image read by the upper surface reader.

7. The inspection system according to claim 6, wherein the controller diagnoses the image forming unit based on the test image read by the upper surface reader and the test image read by the lower surface reader.

8. The inspection system according to claim 7, further comprising an operation unit that is capable of being operated by a user to make a setting related to the inspection system,
wherein the controller notifies the operation unit of a location where a malfunction has occurred based on the diagnosis.

9. The inspection system according to claim 8, wherein in a case where a same defect is found in both the test image read by the upper surface reader and the test image read by the lower surface reader, the controller determines that a malfunction has occurred in the image forming unit.

10. The inspection system according to claim 9, wherein in a case where there is a defect only in the test image read by the lower surface reader, out of the test image read by the upper surface reader and the test image read by the lower surface reader, the controller determines that a malfunction has occurred in the lower surface reader.

11. The inspection system according to claim 1, wherein the sheet of paper on which the test image to be read by the lower surface reader is formed has the test image and a non-image portion on which the test image is not formed.

12. The inspection system according to claim 11, wherein the test image to be read by the lower surface reader is formed with black toner.

13. The inspection system according to claim 1, further comprising:
an image forming apparatus including the image forming unit and the reading unit; and
another controller configured to instruct the image forming apparatus to output the test image.
